(19) United States
(12) Patent Application Publication
(10) Pub. No.: US 2011/0174855 A1
(43) Pub. Date: Jul. 21, 2011

(54) VEHICLE TOP CARRIERS

(75) Inventors: Jason Carothers, Portland, OR (US); Jeff Castro, Portland, OR (US); Dominic D'Andrea, Portland, OR (US)

(73) Assignee: Yakima Products, Inc., Beaverton, OR (US)

(21) Appl. No.: 12/911,653

(22) Filed: Oct. 25, 2010

Related U.S. Application Data
(63) Continuation-in-part of application No. 11/606,638, filed on Nov. 29, 2006, now abandoned.
(60) Provisional application No. 61/254,618, filed on Oct. 23, 2009.

(51) Int. Cl. B60R 9/055

(52) U.S. Cl. 224/328

(57) ABSTRACT

An elongate cargo box includes a bottom portion and a lid. The bottom portion has clamps for connecting the box to a pair of crossbars on top of a vehicle. The lid is hinged to the bottom by a latch assembly including multiple latch devices. The lid may have transverse beams fastened to an inner surface of the lid.

### CROSS-REFERENCE TO RELATED APPLICATIONS

This is a continuation-in-part of application Ser. No. 11/606,638 filed Nov. 29, 2006 and claims priority from U.S. Provisional Patent Application Ser. No. 61/254,618, filed Oct. 23, 2009 which is incorporated herein by reference.

This application also incorporates by reference in their entirety for all purposes the following U.S. patents and patent applications: U.S. Pat. Nos. 6,905,053, issued Jun. 14, 2005; 6,918,521, issued Jul. 19, 2005; Ser. No. 10/767,398, filed Jan. 28, 2004; Ser. No. 11/152,674, filed Jun. 13, 2005; Ser. No. 60/729,503, filed Oct. 21, 2005 and Ser. No. 60/740,705 filed Nov. 29, 2005.

### FIELD OF THE INVENTION

The invention relates to assemblies for carrying cargo items on a vehicle. In particular, the invention provides improvements for cargo boxes or cargo trunks designed for mounting on a roof of a vehicle.

### BACKGROUND

Vehicle top carriers, such as cargo boxes or cargo trunks, have become quite popular in recent years. Enclosed carriers may be preferable over conventional open racks for a variety of reasons. For example, enclosed carriers protect cargo items from the elements such as wind, rain, and snow. Additionally, enclosed carriers may be more secure from theft or vandalism.

Some vehicle top carriers, however, have problems associated with their use. For example, some cargo carriers have lids that are prone to opening and closing problems. If a lid on a vehicle cargo box does not close completely, reliably, and consistently, then catastrophic results may occur if the box opens while driving down the road. There is a significant need for more reliable opening and closing systems for a top-of-car cargo box.

### SUMMARY

A box configured for mounting on top of a vehicle includes a series of coordinated latches connecting a lid to a bottom, and corresponding ribs fastened to an inner surface of the lid.

### BRIEF DESCRIPTION OF THE DRAWINGS

FIG. 1 is a side view of a cargo carrier mounted on top of a vehicle.

FIG. 2A is an exploded perspective view of the box shown in FIG. 1.

FIG. 2B is a partially cut away perspective view of a cargo box lid.

FIG. 3 is a perspective view of a stiffening member configured for reinforcing the lid of a cargo box.

FIGS. 3A-3C are partial perspective interior views of a cargo box, illustrating hinge/latch devices and corresponding transverse beams mounted in the lid.

FIG. 4 is a cross-sectional view through the lid and reinforcing structure illustrated in FIG. 1.

FIGS. 5 and 6 illustrate alternative lid reinforcing structures.

FIGS. 7 and 8 illustrate net devices used to secure cargo items on the inner side of cargo box lid.

### DETAILED DESCRIPTION

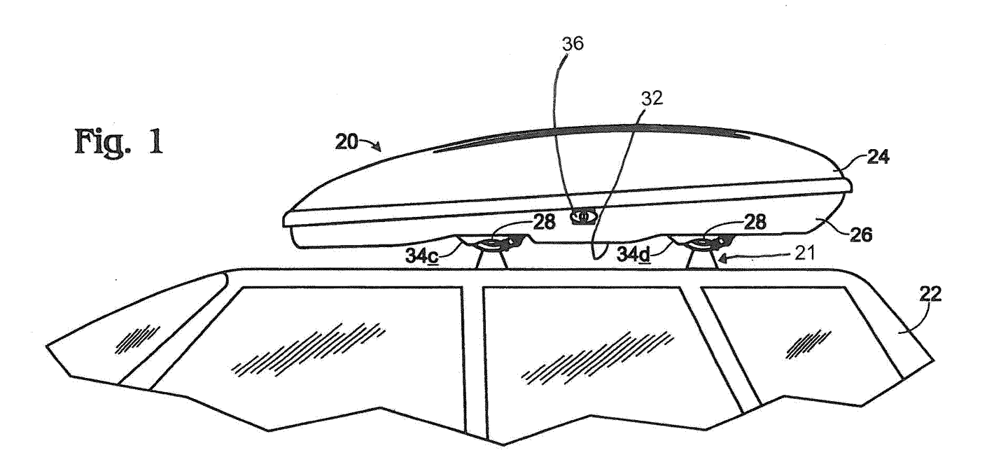

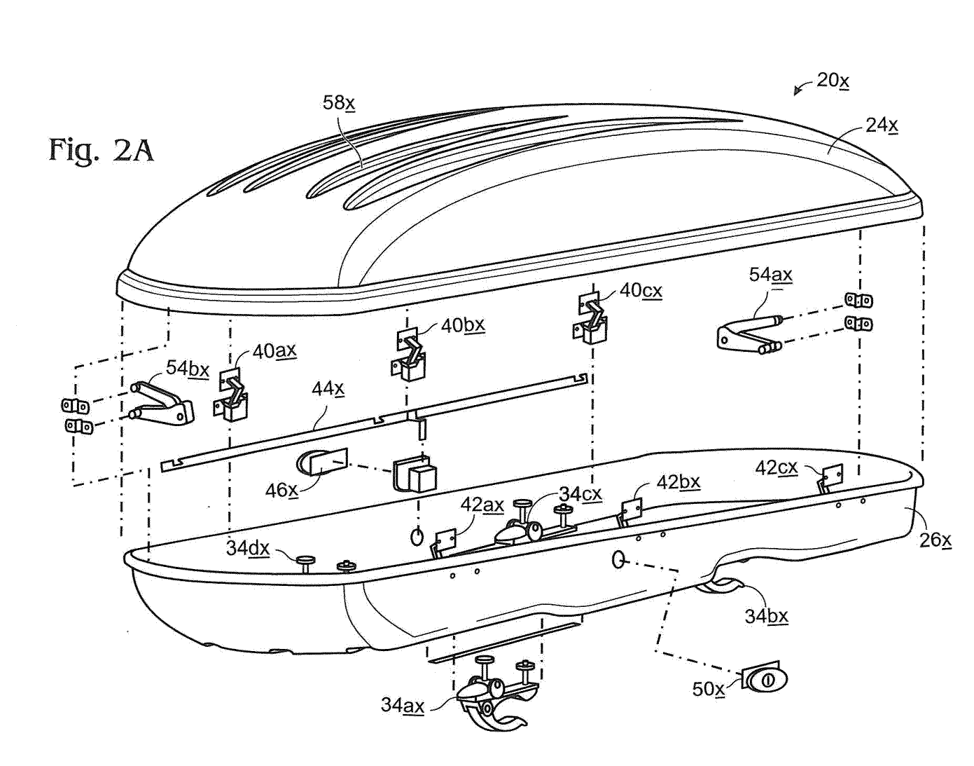

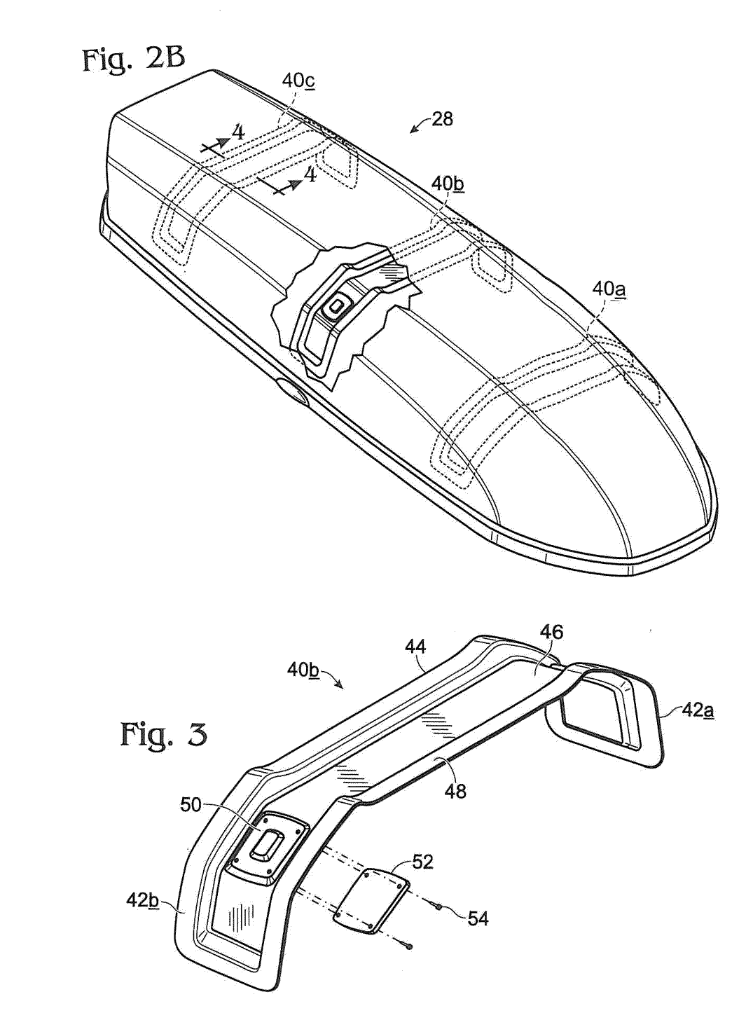

FIG. 1 shows a vehicle top carrier 20 mounted on crossbars 28 of roof rack 21 on vehicle 22. The long axis of vehicle top carrier 20 is perpendicular to crossbars 22. Vehicle top carrier or box 20 includes top or lid 24 connected via hinges (FIG. 2A) to bottom portion 26, including floor 32. Four clamps (only two are shown) 34c, 34d secure vehicle top carrier 20 to crossbars 28. Latch handle 36 keeps vehicle top carrier 20 closed, and may be operated to allow opening when desired. Latch handle 36 may be provided with a key device, combination operated device, and/or any suitable lock mechanism. Box 20 may have sets of hinges on one, two or more sides permitting opening of the box on one, two or more sides. Hinges for box 20 may be dual functioning alternately as a hinge or a latch. In a preferred design, each lateral side of the box is equipped with a set of latch/hinges so that the box may be opened from either side of the box.

FIG. 2A shows an exploded view of car top carrier or box 20x. Mounting hardware is provided for easily securing carrier 20x to the vehicle rack. For example, four mounting mechanisms 34ax-dx may be provided for this purpose. Each mounting mechanism includes a cam lever for operating a jaw mechanism to clamp around a crossbar, as explained in more detail below. The clamps may be provided completely preassembled with the box. The clamps never need to be disassembled as the carrier is put on and off one or more cars through the life of the product. Each clamp may be adjustable to grip, with variable force, crossbars of different dimensions. The clamps may also be adjustable to different locations on the floor of the box, for example, along an axis parallel to the direction of vehicle travel. The clamps are preferably configured so that once the carrier clamps are adjusted for a particular vehicle configuration, the carrier can be easily installed or removed by simply manipulating each cam lever with a single, one step, switch, toggle, rotation, stroke or other quick-action, for example, with an over-center assist mechanism.

Sets of hinge/latch mechanisms may also be provided on each side of carrier 20x to allow opening of the carrier from opposite sides. In FIG. 2A, hinge/latch mechanisms 40ax-40cx are mounted on one side of carrier 20x to connect top 24x to bottom 26x. Similarly, on the other side of carrier 20x, hinge/latch mechanisms 42ax-42cx connect top 24x to bottom 26x. Actuating bar 44x is mounted inside carrier 20x for operating and synchronizing hinge/latch function of mechanisms 40ax-40cx. Actuating bar 44x may be operated, i.e., moved forward and backward relative to the long axis of carrier 20x, by manipulating switch, handle, or key device 46x from the exterior of carrier 20x. A similar actuating bar (not shown) is used to operate hinge/latch mechanisms 42ax-cx via switch, handle, or key device 50x.

Lid supports 54ax and 54bx are mounted at the front and back ends of carrier 20x, connecting top 24x to bottom 26x. Lid supports 54ax and 54bx stabilize top 24x when moving between open and closed positions. Lid supports 54ax and 54bx may also limit the extent of potential opening of carrier 20x. For example, lid supports 54ax, 54bx, may limit the extent of opening on either side of carrier 20x to approximately 16-inches. Longitudinal ribs or indentations 58x may be formed in carrier top 24x to provide stiffening and increased strength for carrier 20x, and may also be desirable aesthetically.

FIG. 2B shows an example of a preferred lid assembly which is useful in a cargo box having hinge/latch assemblies like the ones illustrated in FIG. 2A. Lid 28 has three transverse stiffening members or beams 40a, 40b and 40c bonded to an interior surface of lid 28. Comparison of FIGS. 2A and 2B show that beams 40a, 40b and 40c line up and correspond at least approximately with hinge/latches 40ax, 40bx, and 40cx, respectively. Reliable coordinated latch function of hinge/latches 40ax, 40bx, and 40cx may be enhanced significantly by fastening a transverse beam for each hinge/latch across the inner surface of the lid substantially spanning from one side of the lid to the other side. For a dual side opening box, such as the one shown in FIG. 2A, each beam substantially corresponds to an opposing pair of hinges/latches on opposite sides of the box, substantially spanning between one hinge/latch, to the opposing hinge/latch, for example, 40ax to 42ax in FIG. 2A.

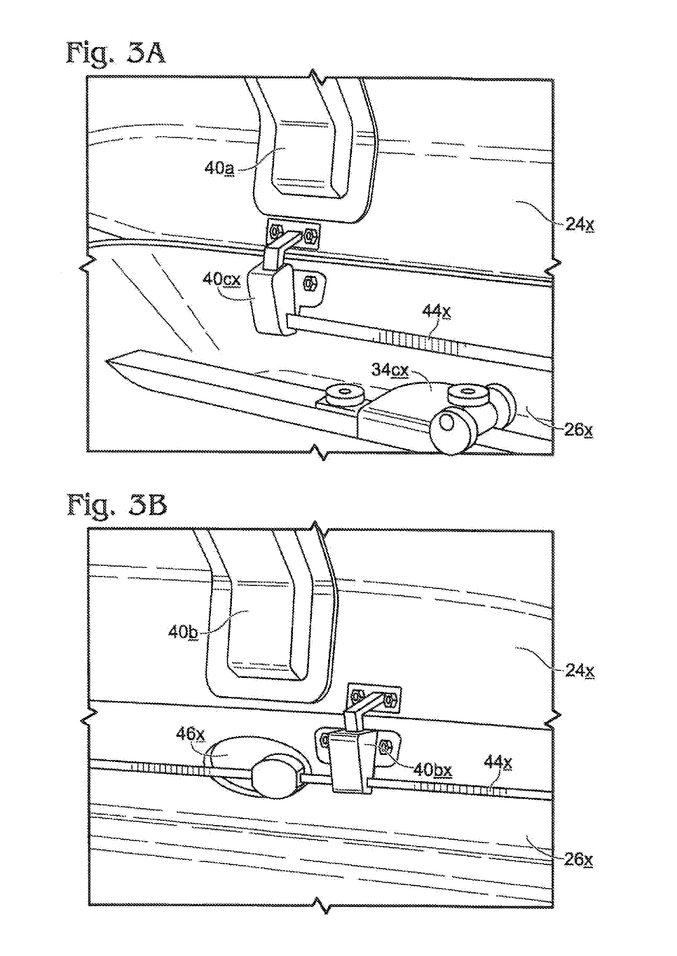

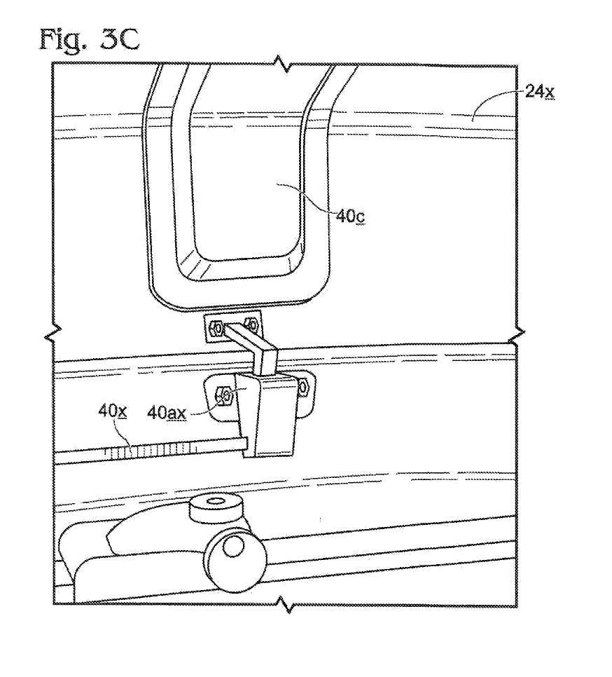

FIG. 3 shows an isolated perspective view of lid stiffening member or beam 40b. Beam 40b may also be referred to as a hinge/latch cross-over structure. Beam 40b includes leg portions 42a and 42b connected to center beam portion 44. Internal recess 46 spans from leg portion 42a through center beam portion 44 to leg portion 42b. Flange 48 forms a continuous boundary around recess 46, providing a parametric surface for bonding to the internal surface of lid 28. As shown in FIG. 3, stiffening member 40b has a pre-formed semi-rigid shape substantially conforming to the shape of the inner surface of lid 28. In a preferred lid configuration, adhesive is used to bond flange 48 to the inner surface of lid 28. Any appropriate adhesive may be used along with appropriate clamping or curing techniques, as are well known in the art. Recess 46 also includes one or more, preferably two, cavities 50 for mounting accessories such as light device 52 by screws 54.

FIGS. 3A-3C show interior views of a cargo box, specifically relative locations of rear, middle, and front hinge/latch devices and corresponding transverse beams mounted on an inner surface of the lid.

In FIG. 3A, clamp 34cx is used, along with other clamps (not shown), to mount the cargo box on a pair of crossbars on top of a vehicle. Hinge/latch device 40cx is used, along with other hinge/latches shown in FIGS. 3B and 3C, to connect lid 24x to bottom 26x. Hinge/latch device 40cx is coordinated with other hinge/latch devices shown in FIGS. 3B and 3C, by bar 44x. As shown in FIG. 3A, beam or stiffening member 40a is aligned with hinge/latch device 40cx.

FIG. 3B shows hinge/latch device 40bx and corresponding beam or stiffening member 40b. As shown in FIG. 3B, hinge/latch device 40bx is substantially aligned with corresponding beam 40b, however, offset a little to the side to accommodate switch, handle, or key device 46x.

Similarly, FIG. 3C shows front hinge/latch device 40ax aligned with corresponding beam or stiffening member 40c.

FIG. 4 shows a cross section through lid 28 and beam 40a. Flange 48 is bonded to inner surface 58 of lid 28. Recess 46 creates angled walls 60a, 60b and 60c spaced away from inner surface 58 of lid 28 which creates a stiffening, torsion stabilizing effect on lid 28. In a lid such as the one shown in FIG. 2, having a long axis, and being hinged at multiple points with respect to a bottom portion of the box, one or more, preferably three, substantially parallel, transverse stiffening members provide desirable stiffening benefits to the cargo box lid.

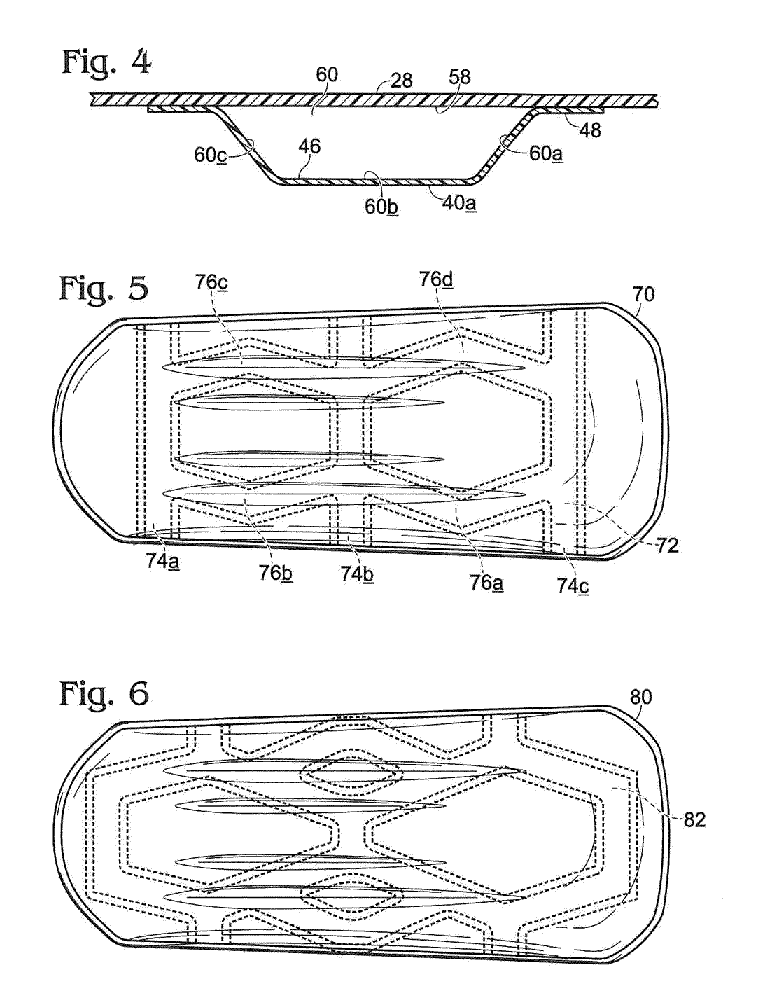

FIGS. 5 and 6 show alternative stiffening member configurations. In FIG. 5, lid 70 has a single, more extensive stiffening member 72 including three transverse components 74a-c, connected by angular cross components 76a-d. FIG. 6 shows lid 80 including another stiffening member configuration 82. Many different levels and/or orientations of stiffening, or torsion stability, may be achieved by using different stiffening member configurations. Selection of an appropriate stiffening member configuration may involve consideration of lid material composition, geometry, points of attachment to the bottom, functional goals relative to lid opening and closing, coordination with internal accessories or cargo items inside the box, etc.

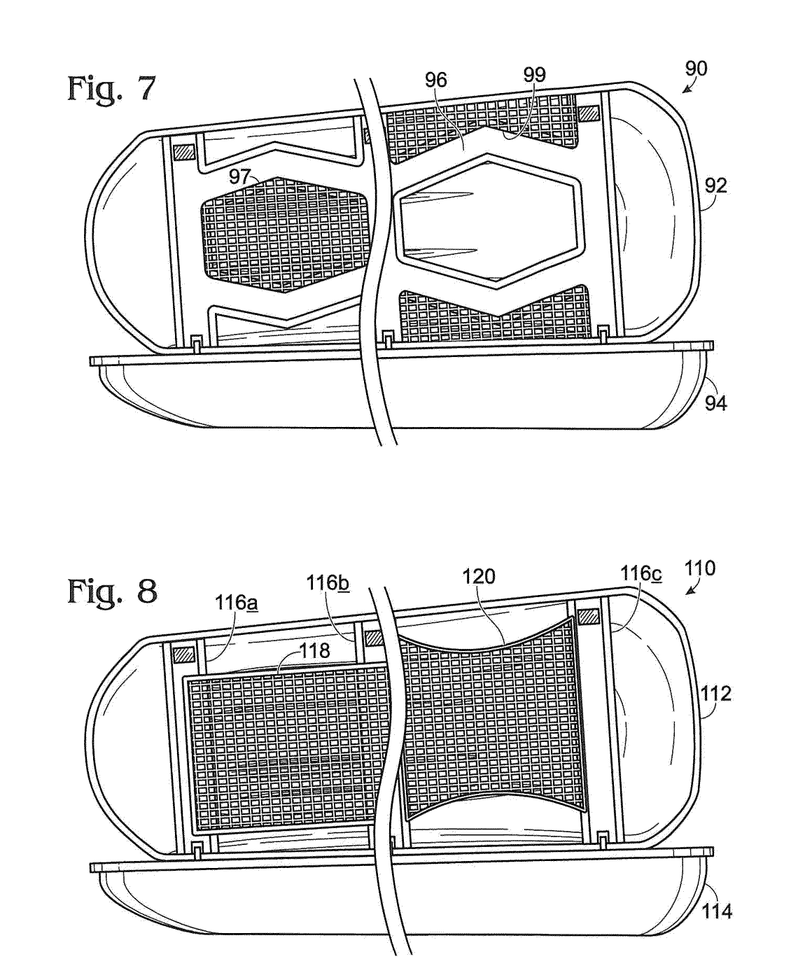

FIGS. 7 and 8 show alternative embodiments in which cargo nets are integrated with stiffening members, providing various compartments for carrying selected cargo items. In FIG. 7, box 90 includes lid 92, hinged at three locations to bottom portion 94. Stiffening member 96 is bonded to interior surface of lid 92. Nets 97 and 99 are at least partially attached to points along stiffening member 96. The nets may include suitable opening and closing devices (not shown) for carrying selected cargo items. Similarly, FIG. 8 shows box 110 including lid 112 hinged to bottom portion 114. Transverse stiffening members 116a-c are bonded to lid 112. Transverse stiffening members 116a-c are bonded to inner surface of lid 112. Cargo nets 118 and 120 are secured to stiffening members 116a-c to provide compartments for carrying selected cargo items in internal spaces adjacent the surface of lid 112.

In addition to the examples discussed above, lid support structures may provide one or more mounting points for any suitable accessories and/or equipment, such as the accessories and/or equipment described in U.S. Provisional Patent Application Ser. No. 60/729,503 entitled “Vehicle Top Carriers” filed on Oct. 21, 2005, the complete disclosure of that application has been incorporated by reference for all purposes.

Support structures may be mounted to the underside of a lid by any suitable method. Support structures may be mounted by mechanical and/or chemical bonding. Support structures may also be formed as part of the lid.

Lid support structures also may be any suitable shape. For example, support structures may have a generally elongate shape with a rectangular cross-section that conforms to the shape of the underside of a cargo box lid. Support structures may have curvilinear and/or other rectilinear cross-sections and/or surfaces.

Support structures may include one or more content retention structures, which may include any suitable structure configured to retain and/or support cargo items in the lid of the carrier. For example, retention structures may include one or more cargo nets such as the ones described above. The cargo nets may be any suitable size and/or number. A single cargo net may span the support structures, and/or a cargo net may be included for each pair of support structures. Cargo nets also may be made of any suitable material, such as elastic and/or woven material. Cargo nets may be attached to one or more of the support structures via one or more attachment structures such as grooves, hooks, hook and loop devices, etc.

In addition to the examples discussed above, lights may be mounted or incorporated on or between one or more of the support structures. The lights may include any suitable light emitting structures, such as incandescent and/or light emitting diodes (LEDs). The lights may be powered via any suitable means, such as one or more batteries and/or one or more solar panels. Illumination device switches may be operated manually, such as by user manipulation, and/or automatically, such as when the lid is raised and/or lowered. Illumination devices may be configured to be removable from the lid to allow a user to use those devices for illuminating other areas remote from the box. Illumination devices may be snap-in flashlights and/or stock flashlights held within the underside of the lid via one or more holders.

Lid stiffener concepts described in this application may achieve a number of important benefits. For example, stiffening devices may be used to resist bending of the lid in a transverse direction, the transverse direction being defined as perpendicular to the long axis of the box.

Stiffening devices may improve the cross sectional moment of inertia (I) to prevent the lid from bending. This may be accomplished by adding height between the outer and inner materials, for example, between a stiffening structure and the outer shell.

Lid stiffness may also be achieved by using a thicker or stiffer (more rigid, less flexible) material for the shell of the lid. However, thicker and/or stiffer materials may be more expensive and may require more complex and/or expensive fabrication techniques.

Another objective may be to improve the resistance of the lid to racking. This may be accomplished by increasing the polar moment of inertia (J) of a cross section of the rib to prevent the lid from twisting and racking. A tubular rib may be used. For example, a tube may be formed by bonding a concave structure to the inside of the lid shell.

Lid stiffness may also be achieved by making the perimeter of the lid stiffer. Twin sheet thermoforming may be used to add thicker areas to the lid. Tubes may be fastened at the ends or in the middle of the lid. Ribs may be fastened. Ribs may be bonded to the inside of the lid at discrete points. Ribs may have flanges for bonding to the lid's interior surface. Flanges for bonding may be perimetral or internal. Flanges may be continuous or discretely spread apart or separated. A rib may have a single flange or may have multiple flanges. Ribs may be attached to the interior of a lid without flanges. A rib may be heat staked to the interior of the lid. Spray foam ribs may also be used. Ribs may be made by injection molding, blow molding, or rotomolding. Cast ribs are an option as well. Ribs may also be attached to the lid by a mechanical interlock mechanism.

The lid may also be made stiffer or more rigid by attaching a tube around the perimeter of the lid. The tube may be made of steel, plastic or some other suitable material.

Lay up fiberglass or carbon fiber may be used inside a thermoformed lid for stiffening. A foam spacer may be used between the fiberglass and the lid to form ribs. Alternatively, a thin thermoformed spacer between the fiberglass and the lid may be used to form a rib.

A separate skin and rib structure may be used. The lid may have an exo-skeleton, for example, ribs on the outside of the lid. The ribs may be bonded to the lid before thermoforming. A lid may be injection molded with integrated ribs. Reaction injection molding (RIM) with integrated ribs may be used to make a lid. The lid may be rotomolded. Ribs may form a complete tube before attaching to the interior of the lid.

Other types of ribs may also be used, for example, compression form ribs, pultrusion ribs, laminated steel ribs, carbon fibre layup ribs, etc. In another configuration a steel belt is secured around the perimeter plus at least one rib.

Another lid configuration uses two thin sheets (inner and outer) with foam spacing in the middle, or another type of suitable spacing. A lid may have no inner skin, and instead have an inner surface of foam to be formed by the mold (like a bike helmet). Fiberglass may be added inside the lid to thicken and stiffen the shell. A lid may have a stamped sheet metal top, and/or formed pulp ribs with waterproof coating. Thermoform corrugated sheets may also be used.

Although vehicle top carriers and features of vehicle top carriers have been shown and described with reference to the foregoing operational principles and preferred embodiments, those skilled in the art will recognize that various changes in form and detail may be made without departing from the spirit and scope of the claims. The present disclosure is intended to embrace all such alternatives, modifications, and variations.

We claim:

1. A rack system for carrying cargo on top of a vehicle comprising
a pair of crossbars, each crossbar having a pair of towers configured to secure the crossbar on top of a vehicle in a perpendicular orientation relative to the vehicle's direction of travel,
a cargo box having a long axis and including a lid and a bottom, the bottom having clamps for securing the bottom to the crossbars, the long axis of the box being perpendicular to the crossbars, wherein the cargo box has a first side and a second side substantially parallel to the long axis, the lid being hinged to the bottom along the first side, the second side of the cargo box having a latch assembly including plural latch devices spaced apart from each other along the second side, a handle, and a bar member connecting and coordinating operation of the latch devices under manipulable control via the handle, the lid having an inner surface, each latch device having a corresponding transverse beam fastened to the inner surface of the lid, the beam having a long axis oriented perpendicular to the long axis of the cargo box and spanning most of the way from the first side to the second side of the cargo box.

2. The rack system of claim 1, wherein each side of the cargo box has a hinge/latch assembly including multiple hinge/latch devices, each hinge latch device being configured to operate, alternately, as a hinge and as a latch, allowing the cargo box to be opened, alternately, from the first side and from the second side.

3. The rack system of claim 1, wherein the beams are substantially aligned with the latch devices.

4. The rack system of claim 2, wherein each beam spans most of the distance from a hinge/latch device on the first side to a hinge/latch device on a second side of the cargo box.

5. The rack system of claim 1, wherein each beam has flange which is bonded to the inner surface of the lid.

6. The rack system of claim 1, wherein there is a one to one correspondence between the number of latch devices on the second side and the number of beams fastened to the inner surface of the lid.

7. The rack system of claim 1, wherein the handle is centrally located along the second side of the cargo box.

8. The rack system of claim 1, wherein the latch assembly has three latch devices and three corresponding transverse beams.

9. A container system for carrying cargo on top of a vehicle, the vehicle having a front, a back, and a long axis running from the back to the front of the vehicle, comprising
a pair of crossbars for carrying cargo on top of a vehicle, each crossbar having a pair of towers for connecting the crossbar to a vehicle roof, the crossbars being configured for mounting substantially parallel to each other, and perpendicular to the long axis of the vehicle,
an elongate box having an elongate axis, a bottom portion, a lid, two opposing opening sides parallel to the elongate axis, and a clamp system configured for securing the bottom portion of the box to the crossbars, the elongate axis of the box being substantially parallel to the long axis of the vehicle, the lid having a front end, a rear end, and two lateral sides running between the front and rear ends, the opening sides of the box corresponding to the lateral sides of the lid, each of the lateral sides of the lid being connected to the bottom portion of the box by a hinge assembly including multiple coordinated latch devices mounted along the respective lateral side of the lid, each latch configured to operate alternately as a latch and as a hinge, thereby allowing opening of the box from either opening side of the box, and
wherein the lid has a concave interior surface, a continuous perimeter lip portion fitting over an upper edge of the bottom portion when the box is closed, and a plurality of transverse ribs fastened and conforming to the interior surface of the lid, each rib (a) having a long axis perpendicular to the elongate axis of the box, (b) spanning at least most of the distance from one opening side of the box to the other opening side of the box, and (c) being substantially aligned with a latch on one side of the box and a corresponding latch on the other side of the box.

10. The container system of claim 9, wherein each rib has a continuous border flange surrounding a recess, the flange being rigidly fastened to the interior surface of the lid without creating any holes in the lid.

11. The container system of claim 9, wherein each hitch assembly has three latch devices and three corresponding transverse ribs.

12. A container system for carrying cargo on top of a vehicle comprising
a cargo box having a long axis and including a lid and a bottom, the bottom having clamps for securing the bottom to a pair of crossbars, the long axis of the box being perpendicular to the crossbars, wherein the cargo box has a first side and a second side substantially parallel to the long axis, each of the first and second sides of the box having a hinge/latch assembly connecting the lid to the bottom, allowing alternate opening of the lid from the first and second sides of the box, each hinge/latch assembly including plural hinge/latch devices distributed along the respective side of the box, and a coordination bar cooperatively linking the hinge/latch devices, and
a set of transverse beams fastened to an inner surface of the lid, each beam having a long axis perpendicular to the long axis of the box and substantially spanning from a hinge/latch device on the first side of the box to a corresponding hinge/latch device on the second side of the box.

13. The container of claim 12, wherein each hinge/latch device has a transverse beam connecting the hinge/latch device to a corresponding hinge/latch device on the other side of the box.

14. The container of claim 12, wherein each hinge/latch assembly has three hinge/latch assemblies, and the lid has three transverse beams.
